(19) United States
(12) Patent Application Publication
(10) Pub. No.: US 2019/0077521 A1
(43) Pub. Date: Mar. 14, 2019

(54) Fueling Station

(71) Applicant: Intelligent Energy Limited, Loughborough (GB)

(72) Inventors: Andrew Paul KELLY, Loughborough, Leicestershire (GB); Zachary ELLIOTT, Loughborough, Leicestershire (GB); Paul Leonard ADCOCK, Loughborough, Leicestershire (GB)

(73) Assignee: Intelligent Energy Limited, Loughborough (GB)

(21) Appl. No.: 15/772,490

(22) PCT Filed: Oct. 26, 2016
(86) PCT No.: PCT/GB2016/053328

§ 371 Date: Apr. 30, 2018

(30) Foreign Application Priority Data
Oct. 30, 2015 (GB) 1519206.5

(51) Int. Cl. B64F 1/28; B64C 39/02; B60S 5/02; B67D 7/04

(52) U.S. Cl. CPC B64F 1/28; B64C 39/024; B67D 7/3209; B67D 7/0401; B60S 5/02

(57) ABSTRACT

The application relates to a fueling station for a fuel generator having a fuel generator reservoir, the fueling station comprising: a station reservoir (11) for storing at least one reactant for fuel generation; a fueling interface (14) configured to engage with the fuel generator reservoir and dispense the at least one reactant to the fuel generator reservoir; and a controller (18) configured to: receive a parameter indicative of an intended use of the fuel generator; and control the fueling interface to dispense the at least one reactant in accordance with the parameter.

The invention relates to a fueling station for a fuel generator and in particular, although not exclusively, to a ground station for an unmanned aerial vehicle.

Unmanned aerial vehicles (UAVs) have many applications including reconnaissance, remote sensing and providing an airborne base for a telecommunications transceiver. UAVs are typically smaller than manned aircraft and may weigh between a few grams and 20 kilograms, for example. The expression “unmanned aerial vehicle” as used herein is intended to encompass aerial vehicles not capable of conveying a pilot.

Electrochemical fuel cells, such as hydrogen fuel cells, offer are a good choice of power source for UAVs because of their relatively high electrical power output per unit weight. A fuel generator may be used on board a UAV in order to provide fuel for the fuel cell at the point of use. A fuel generator reacts together a plurality of reactants to produce the fuel for the fuel cell. A difficulty arises in providing reactants to the fuel generator in a safe manner whilst minimising weight, which effects the power efficiency of a UAV. Replaceable fuel cartridges may be used to provide reactants to fuel generators. These cartridges often include pressure vessels and, in the case of active cartridges that mix reactants at the point of use, control mechanisms that add weight and complexity.

A further difficulty with conventional cartridges is that they are heavy to transport because, before use, they are full of reactants. This is a particular difficulty in the context of UAV applications in which use of the cartridges is often required in remote locations.

According to a first aspect of the invention there is provided a fueling station for a fuel generator having a fuel generator reservoir, the fueling station comprising:
a station reservoir for storing at least one reactant for fuel generation;
a fueling interface configured to engage with the fuel generator reservoir and dispense the at least one reactant to the fuel generator reservoir; and
a controller configured to:
   receive a parameter indicative of an intended use of the fuel generator; and
   control the fueling interface to dispense a quantity of the at least one reactant in accordance with the parameter.

The intended use may relate to a future use of the fuel generator. In the case where the fuel generator is provided on a vehicle, the intended use of the fuel generator may correspond to the intended use of the vehicle. The parameter may define a quantity of fuel that the fuel generator will be required to generate in a single session.

The fueling station may comprise a data interface configured to receive the parameter from a computerised device. The parameter may relates to one or more of a flight plan parameter from a flight plan of the aerial vehicle, an ambient temperature, an atmospheric condition, a payload of the aerial vehicle, a type of the aerial vehicle. The station reservoir may have a plurality of compartments. Each compartment may comprise a different reactant. The fueling interface may comprise a mixing device configured to mix the different reactants during dispensation of the different reactants to the fuel generator reservoir. The fuel generator reservoir and the station reservoir may each have a plurality of corresponding compartments. Each compartment may comprise a different reactant. The fueling interface may be configured to dispense the different reactants into the corresponding compartments of the fuel generator reservoir.

The at least one reactant may comprise an aqueous solution. The at least one reactant may be water. The station reservoir may comprise a water compartment. The water compartment may have a port for connecting to a utility network.

The fueling interface may be configured to receive data from the reactant cartridge. The data may be indicative of one or more of an identifier of the cartridge, an age of the cartridge, a reaction condition within the cartridge, a temperature of the cartridge, a pressure within the cartridge, a usage history of the cartridge, a leak integrity status of the cartridge, and a capacity of the cartridge. The controller is further configured to control the fueling interface to dispense the at least one reactant in accordance with the received data.

The fueling station may comprise a cleaning liquid reservoir for storing a cleaning liquid. The fueling interface may be configured to provide the cleaning liquid to the fuel generator reservoir. The cleaning interface that is different to the fueling interface may be configured to provide the cleaning liquid to the fuel generator reservoir.

The fueling station may comprise a reaction terminator reservoir for storing a chemical for reducing a rate of reaction in the fuel generator reservoir. The fueling interface may be configured to provide the chemical to the fuel generator reservoir. A termination interface that is different from the fueling interface may be configured to provide the chemical to the fuel generator reservoir. The fueling or termination interface may be configured to label a cartridge comprising the fuel generator reservoir in conjunction with providing the chemical.

The fueling station may comprise a neutraliser reservoir for storing a chemical for neutralising a pH of a reactant in the fuel generator reservoir. The fueling interface may be configured to provide the chemical to the fuel generator reservoir. The chemical may be an acid. A neutraliser interface that is different from the fueling interface and/or termination interface may be configured to provide the chemical to the fuel generator reservoir. The fueling or neutraliser interface may be configured to label a cartridge comprising the fuel generator reservoir in conjunction with providing the chemical.

The fueling station may comprise a reactant flow meter configured to determine an amount of reactant that has been dispensed. The controller may further control the fueling interface to dispense a quantity of the at least one reactant in accordance with the amount of reactant that has been dispensed.

The fueling interface may be configured to engage with a plurality of reactant cartridges simultaneously in order to dispense the at least one reactant to the plurality of reactant cartridges.

According to a further aspect of the invention there is provided a ground station for an aerial vehicle. The ground station may comprise the fueling station. The ground station may be portable. The ground station may comprise a computerised flight plan controller. The flight plan controller may configured to generate the parameter in accordance with a flight plan of the aerial vehicle.

According to a further aspect of the invention there is provided a method of servicing a fuel generator reservoir, comprising:
determining a parameter in accordance with an intended use of the fuel generator;
dispensing at least one reactant from a reservoir to the fuel generator reservoir in accordance with the parameter.

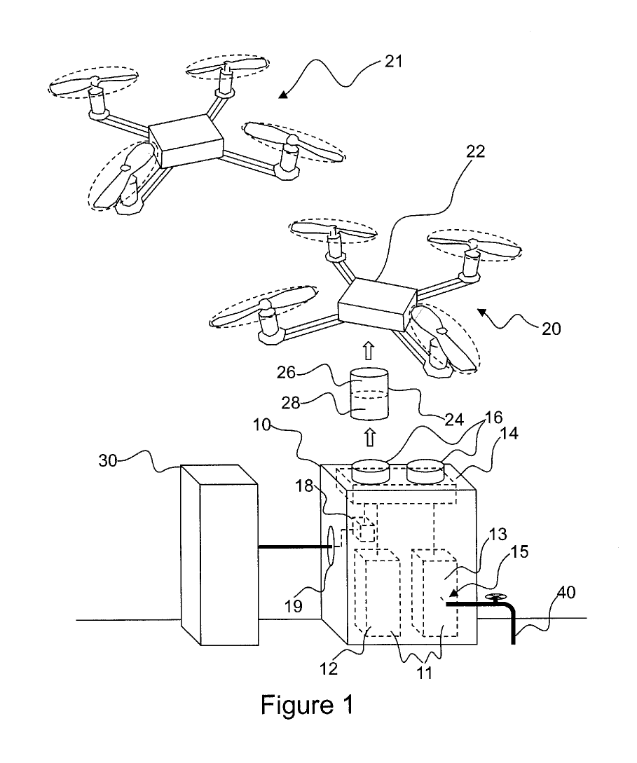

Embodiments of the present invention will now be described by way of example and with reference to the accompanying drawings in which FIG. 1 illustrates a schematic representation of a ground station system including a computerised device and a fueling station for refueling aerial vehicles.

The disclosure relates to a fueling station configured to dispense a quantity of reactant for a fuel generator in accordance with an intended use of the fuel generator. Providing a quantity of fuel in accordance with the intended use enables the fuel generator to operate safely in a single-shot manner in which after initiation of a reaction for generating fuel, the reaction in the fuel generator proceeds until substantially all of the reactant is consumed.

In this way, the complexity of reactant control mechanisms in the fuel generator may be reduced. Additionally, safety concerns regarding the reaction of unspent fuel in a single shot fuel generator after it has performed its intended use may be obviated.

In some examples, the fueling station may dispense water as a reactant. Water is a relatively bulky and heavy reactant that is required for generating fuel using some types of fuel generator. Water is also widely available and so can be provided by a fueling station situated at an intended site of use of the fuel generator. The provision of water at the site of use avoids the cost and difficulty of transporting water to the site of use as a preloaded reactant within the fuel generator or in a fuel cartridge for the fuel generator.

FIG. 1 illustrates a schematic representation of a ground station system 1 for refueling an aerial vehicle 20.

The aerial vehicle 20 in this example is an unmanned aerial vehicle provided by a quad copter, which is a type of rotorcraft. A fuel generator 22 is located on the aerial vehicle 20 for generating fuel for a fuel cell (not shown) during flight. The fuel cell may be a hydrogen fuel cell configured to generate electricity for powering the aerial vehicle 20 from hydrogen and the fuel generator 22 may be provided by a known system that converts a plurality of reactants into hydrogen gas using hydrolysis, for example. In such an example, the plurality of reactants may include a first reactant, which may be a chemical hydride such as sodium borohydride or potassium borohydride, and a second reactant, which may include an aqueous solution such as water, that react together to evolve hydrogen gas. Other examples of first reactants for use with an aqueous second reactant include other metal borohydrides, nano-silicon, aluminium and other metals made active for water splitting, lithium hydride, lithium aluminium hydride, sodium aluminium hydride, calcium hydride and sodium silicide. In other examples, a thermolysis fuel may be used in the fuel generator 22. Thermolysis fuels include ammonia borane, aluminium hydride (alane) and magnesium borohydride. There are also fuels that require the use of a reformer, such as methane or butane, for example.

In the example shown in FIG. 1, a reactant cartridge 24 provides a fuel generator reservoir for storing at least one reactant for fuel generation. The reactant cartridge 24 is configured to be connected to the fuel generator in order to provide the at least one reactant to the fuel generator 22. Alternatively, the fuel generator reservoir may be a reservoir within the fuel generator 22 itself, such as a reactor chamber. A reservoir may be provided by any chamber or vessel for storing the at least one reactant in the form of a liquid, gas or solid. A solid in the reservoir may be provided as a powder or in a suspension.

In the example illustrated, the fuel generator reservoir has a plurality of compartments 26, 28. Each compartment 26, 28 comprises a different reactant, such as the first reactant and the second reactant described above, which are stored separately within the fuel generator reservoir. The first and second reactants may be mixed within the fuel generator 22 in order to generate fuel for the fuel cell. Alternatively, the fuel generator reservoir may comprise the first and second reactants mixed together within a single compartment. In such an example, a reactant retarding chemical may be provided together with the mixture of the first and second reactants in order to prevent the reaction from occurring during storage of the reactants. Potassium hydroxide or sodium hydroxide, for example, may be used as the reactant retarding chemical in the case where the first reactant is a chemical hydride such as sodium borohydride or potassium borohydride and the second reactant is an aqueous solution such as water. Where the mixture comprises a reactant retarding chemical, a reaction chamber of the fuel generator 22 may comprise a catalyst in order to counteract the effect of the reactant retarding chemical and so enable the reaction between the first reactant and the second reactant within the reaction chamber of the fuel generator 22. Ruthenium, rhodium, nickel, cobalt or platinum may be used to catalyse a reaction between a chemical hydride and an aqueous solution.

The ground station 1 has a fueling station 10 and a computerised device 30 that operate together to refuel aerial vehicles 20, 21 in accordance with intended uses of the aerial vehicles 20, 21. The ground station 10 may be dimensioned such that it is portable and can be carried by a person without the aid of lifting equipment. The ground station 10 may therefore be easily transportable and so can be provided at a location to be used as a launch site for unmanned aerial vehicles 20, 21. The intended use of the aerial vehicle may be defined by a flight plan provided by the computerised device 30. An advantage of refueling the aerial vehicles 20, 21 in accordance with the flight plan is that substantially all of the reactant may be used during a single usage session and so a simplified fuel generator arrangement may be used. For example, in a conventional fuel generator, the reactants are stored separately and mixed with each other in accordance with demand during use whereas the simplified fuel generator arrangement may be provided without compartments to separate the reactants and so substantially all of the reactants are consumed in a single usage session. That is, the reaction may be self-sustaining until all the reactant is consumed once initiation of a reaction has begun in the simplified fuel generator. The weight of separate compartments, valves and control apparatus that may otherwise be required in the fuel generator 22 for controlling the reaction may therefore be eliminated. The weight saving is particularly advantageous for unmanned aerial vehicle applications in which the weight of the on-board fuel generator affects the efficiency of the vehicles 20, 21. Such a fuel generator arrangement may be permissible because substantially all of the reactant is consumed during flight. In contrast, if a substantial amount of reactant were left over after a flight is complete then the remaining reactant in such a hydrogen generator could present a safety hazard due to pressure build-up or heat generation post flight.

The fueling station 10 has a station reservoir 11 for storing at least one reactant for fuel generation. The fueling station may store substantially more reactant than can be loaded onto an individual aerial vehicle 20, 21. The arrangement of the station reservoir 11 in this example corresponds to that of the fuel generator reservoir in that the station reservoir 11 has one or more compartments 12, 13 that correspond to the one or more compartments 26, 28 of the fuel generator reservoir. In the example shown in FIG. 1, a first compartment 26 is provided for storing a first reactant and a second compartment 28 is provided for storing a second reactant.

In the example shown, the second reactant is water. By providing water at the point of use, the fueling station removes the need to transport water within the cartridges and so the associated weight can be eliminated during transportation of the cartridge to the site of use. The second compartment 13 of the station reservoir 11 has a port 15 that is connected to a municipal water supply 40 for replenishing water within the station reservoir 11. A valve may be provided in order to control the flow of water into the station reservoir 11 from the municipal water supply 40. The water provided to the station reservoir 11 may comprise 99 wt. % or more water and may have a pH between 6 and 8. In order to provide water suitable for use in some hydrogen generators it may be necessary to treat the water. For example, a water purification or deionisation module may be provided between the municipal water supply 40 and the station reservoir 11.

As an alternatively to the example shown in FIG. 1, the station reservoir may have a single compartment for storing a mixture of the first and second reactants and, optionally, a reactant retarding chemical as described above.

A fueling interface 14 of the fueling station 10 is connected to the station reservoir 11 in order to receive the at least one reactant from the station reservoir 11. The fueling interface 14 is configured to engage with the fuel generator reservoir 24 and dispense the at least one reactant from the station reservoir 11 to the fuel generator reservoir 24. The fueling interface 14 optionally has a plurality of ports 16 for engaging with a respective plurality of reactant cartridges simultaneously. In this way, the fueling station 10 may be used to service a plurality of fuel generator reservoirs at a particular time.

In the example shown in FIG. 1, the station reservoir 11 has a plurality of compartments 12, 13 comprising different reactants and corresponding compartments 26, 28 are provided in the fuel generator reservoir. In this example, the fueling interface 14 provides a plurality of separate reactant flow paths between the compartments 12, 13 in the station reservoir 11 and the corresponding compartments 26, 28 in the fuel generator reservoir. Alternatively, for examples in which the fuel generator reservoir comprises a single compartment for storing a mixture of reactants, the fueling interface 14 may include a mixing device for mixing the different reactants during dispensation of the reactants from the fueling station 10 to the fuel generator reservoir. It is preferable for the reactants to be stored separately from one another within the fueling station 10 before dispensation to the fuel generator reservoir in order to prevent a reaction occurring within the fueling station 10, which could lead to the depletion of the reactant stock in addition to a build-up in temperature and pressure. In this way, the materials and structural requirements of the fueling station 10 may be reduced.

The fueling station 10 has a controller 18 for controlling reactant dispensation by the fueling interface 14. Although the controller 18 is illustrated as being a discrete component in FIG. 1, it may be distributed within the fueling station 10, or integrated with a number component of the ground station 1.

The controller 18 is configured to receive a parameter indicative of an intended use of the fuel generator and control the fueling interface to dispense a quantity of the at least one reactant in accordance with the parameter. The parameter defines a quantity of fuel that the fuel generator will be required to generate during a single future usage session of the generator. The controller 18 may also control the fueling interface to dispense the quantity of the at least one reactant in accordance with the data received from the reactant cartridge 24, as described above.

The computerised device 30 is provided in the example of FIG. 1 in order to provide the parameter for controlling dispensation of the at least one reactant. In this example, the computerised device 30 is connected to the controller 18 by a data interface 19 of the fueling station 10. Alternatively, the computerised device may be integral with the fueling station 10, as part of the controller 18. The computerised device may be provided by a mobile telecommunications device, such as a smart phone, a laptop or desktop computer, a personal digital assistant or a network terminal, for example.

In some examples, the computerised device 30 provides a flight plan controller that is configured to generate the parameter in accordance with a flight plan of the aerial vehicle. The parameter may therefore be considered to be a flight plan parameter. Examples of flight plan parameters that are potentially useful for determining an amount of fuel that is required to be generated by the fuel generator during a particular flight include an ambient temperature, an atmospheric condition, a payload of the aerial vehicle, a type of the aerial vehicle, an intended flight duration, an altitude profile, an intended flight altitude, which may be a mean or maximum altitude for example, and an intended airspeed. Outputs such as these may be obtained from a variety of commercially available flight planning software.

During use, an operator of the ground station 1 and the unmanned aerial vehicle 20 may engage the reactant cartridge 24 comprising the fuel generator reservoir with the fueling interface 14 of the fueling station 10. In some examples, the engagement may be as simple as pushing the interface into a slot in the fueling station 10 in order to provide a reactant flow path between the station reactant reservoir 11 and the fuel generator reservoir.

A flight plan for the unmanned aerial vehicle 20 may be determined using the flight plan controller function of the computerised device 30. Once determined, a parameter of the flight plan can be provided to the controller 18 of the fueling station 10. Alternatively, the parameter may be an expected flight duration in which case the user may enter the duration directly into the controller 18 using a numeric keypad, for example. In such examples, a more sophisticated flight plan controller may not be required.

The controller 18 then proceeds to dispense a quantity of the at least one reactant from the station reservoir 11 to the fuel generator reservoir in accordance with the parameter.

The user may then remove the reactant cartridge 24 from the fueling interface 14 and engage the reactant cartridge with the unmanned aerial vehicle 20 in order to initiate a reaction within the fuel generator 22. The reaction within the fuel generator 22 will then proceed, unless interrupted, until the at least one reactant in the reactant cartridge is consumed. By providing an amount of reactant suitable for a single flight, the fueling station avoids the difficulties associated with excess reactant being left over in a cartridge after use.

It will be appreciated that the ground station described with reference to FIG. 1 provides merely an example for putting the invention into effect. Various modifications may be made to the fueling station of FIG. 1. For example, the fueling interface may be configured to transfer flight plan data from the computerised device to the fuel cartridges or fuel generator in order to program a flight plan into the unmanned aerial vehicle.

In some examples, the station reservoir may further comprise a cleaning liquid reservoir for storing a cleaning liquid. The fueling interface, or a separate cleaning interface, may be further configured to provide the cleaning liquid to the fuel generator reservoir or fuel generator reactor in order to wash out reactant by-product. This may be achieved by flushing the fuel generator reservoir or fuel generator reactor with water, for example.

In some examples, the station reservoir may further comprise a reaction terminator reservoir for storing a chemical for reducing a rate of reaction in the fuel generator reservoir. Potassium hydroxide and sodium hydroxide are examples of chemicals for reducing the rate of a reaction between an aqueous solution and a chemical hydride such as sodium borohydride or potassium borohydride. The station reservoir may comprise a neutraliser reservoir for storing a chemical for neutralising the pH of a reactant in the fuel generator reservoir. An acid such as hydrochloric acid may be provided to neutralise any remaining alkali reactant. The fueling interface, or a separate reaction terminating or neutralising interface, may be further configured to provide the respective chemical to the fuel generator reservoir. This may be advantageous where a reactant cartridge is returned partially used, perhaps because of an unexpected termination of a flight plan. In such cases the addition of the reaction terminating chemical can be used to make the cartridge safe by effectively stopping the reaction and so preventing temperature and pressure build up within the cartridge. The interface may be arranged to apply a label to a fuel cartridge engaged with the interface in order to indicate that a fuel cartridge has been neutralised and so may be considered safe by the user. The label may be physical or electronic. The physical label may be applied by a sticker gun, for example, that is triggered by engagement of the fuel cartridge with the interface. An electronic label may be transmitted from the interface to the fuel cartridge by a physical connection on engagement of the fuel cartridge with the interface or by a near field communication between the interface and fuel cartridge. The near field communication may be always on or enabled by the fuel cartridge being brought into a proximity of the interface. The interface may also be configured to electronically receive data from the reactant cartridge using method similar to those described above. A variety of useful data may be retrieved from the reactant cartridge for use in controlling dispensation of the at least one reactant to the reactant cartridge. For example, such data may be indicative of one or more of:
an identifier of the cartridge, which may be used in a look-up procedure to find further permanent attributes of the cartridge;
a capacity of the cartridge, which is an example of a permanent attribute of the cartridge, which may be used in order to prevent over filling the cartridge;
an age of the cartridge,
a reaction condition within the cartridge,
a temperature of the cartridge,
a pressure within the cartridge,
a past usage record of the cartridge,
a leak integrity status of the cartridge, all of which may be compared with known safe operating values for the cartridge and dispensation of the one or more reactants may be controlled in accordance with a comparison between the received data and a corresponding known safe operating value.

A flow meter may be provided between the station reservoir and the fueling interface in order to determine an amount of reactant that has been dispensed. The controller may be further configured to control the fueling interface to dispense the quantity of the at least one reactant in accordance with the determined amount of reactant that has been dispensed in order to ensure that the required amount of the at least one reactant is provided to the reservoir.

In some examples, a user may service a fuel generator reservoir of a fuel generator of a vehicle by determining a parameter in accordance with an intended use of the vehicle. The parameter may be an expected trip distance or trip duration, for example. The user may then dispense at least one reactant from a reservoir of a device such as a syringe to the fuel generator reservoir in accordance with the parameter. The device may be calibrated with markings that guide the user how much reactant to dispense for particular trip distances or durations, which may be based on assumed average operating conditions of the vehicle. The user may service the fuel generator reservoir in this way shortly before using the vehicle.

Other embodiments are intentionally within the scope of the appended claims.

1. A fueling station for a fuel generator having a fuel generator reservoir, the fueling station comprising:
a station reservoir for storing at least one reactant for fuel generation;
a fueling interface configured to engage with the fuel generator reservoir and dispense the at least one reactant to the fuel generator reservoir; and
a controller configured to:
receive a parameter indicative of an intended use of the fuel generator;
control the fueling interface to dispense a quantity of the at least one reactant in accordance with the parameter; and
wherein the fueling interface is configured to receive data from the reactant cartridge.

2. The fueling station of claim 1 in which the station reservoir has a plurality of compartments, each compartment comprising a different reactant.

3. The fueling station of claim 2 in which the fueling interface comprises a mixing device configured to mix the different reactants during dispensation of the different reactants to the fuel generator reservoir.

4. The fueling station of claim 2 in which the fuel generator reservoir and the station reservoir each has a plurality of corresponding compartments, each compartment comprising a different reactant, and in which the fueling interface is configured to dispense the different reactants into the corresponding compartments of the fuel generator reservoir.

5. The fueling station of claim 1 in which the at least one reactant comprises water.

6. The fueling station of claim 5 in which the station reservoir comprises a water compartment with a port for receiving water from a utility network.

7. (canceled)

8. The fueling station of claim 1 in which the data is indicative of one or more of an identifier of the cartridge, an age of the cartridge, a reaction condition within the cartridge, a temperature of the cartridge, a pressure within the cartridge, a usage history of the cartridge, a leak integrity status of the cartridge, and a capacity of the cartridge.

9. The fueling station of claim 1 in which the controller is further configured to control the fueling interface to dispense the at least one reactant in accordance with the received data.

10. The fueling station of claim 1 comprising a cleaning liquid reservoir for storing a cleaning liquid, in which the fueling interface is configured to provide the cleaning liquid to the fuel generator reservoir.

11. The fueling station of claim 1 comprising a neutraliser reservoir for storing a chemical for neutralising a pH of a reactant in the fuel generator reservoir, in which the fueling interface is configured to provide the chemical to the fuel generator reservoir.

12. A fuelling station for a fuel generator having a fuel generator reservoir, the fueling station comprising:
a station reservoir for storing at least one reactant for fuel generation;
a fueling interface configured to engage with the fuel generator reservoir and dispense the at least one reactant to the fuel generator reservoir; and
a controller configured to:
receive a parameter indicative of an intended use of the fuel generator;
control the fueling interface to dispense a quantity of the at least one reactant in accordance with the parameter; and,
wherein the fueling interface is configured to receive data from the reactant cartridge;
a neutraliser reservoir for storing a chemical for neutralising a pH of a reactant in the fuel generator reservoir, in which the fueling interface is configured to provide the chemical to the fuel generator reservoir; and, wherein the fueling interface is configured to label a cartridge comprising the fuel generator reservoir in conjunction with providing the chemical.

13. The fueling station of claim 1 in which the intended use relates to a future use of the fuel generator.

14. The fueling station of claim 13 in which the parameter defines a quantity of fuel that the fuel generator will be required to generate in a single session.

15. The fueling station of claim 1 comprising a data interface configured to receive the parameter from a computerised device.

16. The fueling station of claim 1 in which the parameter relates to one or more of a flight plan parameter from a flight plan of the aerial vehicle, an ambient temperature, an atmospheric condition, a payload of the aerial vehicle, a type of the aerial vehicle.

17. The fueling station of claim 1 comprising a reactant flow meter configured to determine an amount of reactant that has been dispensed.

18. The fueling station of claim 12 in which the fueling interface is configured to engage with a plurality of reactant cartridges simultaneously in order to dispense the at least one reactant to the plurality of reactant cartridges.

19. A ground station for an aerial vehicle comprising the fueling station of claim 1.

20. The ground station of claim 19 in which the ground station is portable.

21. The ground station of claim 20 comprising a computerised flight plan controller configured to generate the parameter in accordance with a flight plan of the aerial vehicle.

22. A method of servicing a fuel generator reservoir, comprising:
determining a parameter in accordance with an intended use of the fuel generator;
dispensing at least one reactant from a reservoir to the fuel generator reservoir in accordance with the parameter.

23. (canceled)
